(19) United States
(12) Patent Application Publication
(10) Pub. No.: US 2024/0095180 A1
(43) Pub. Date: Mar. 21, 2024

(54) SYSTEMS AND METHODS FOR INTERPOLATING REGISTER-BASED LOOKUP TABLES

(71) Applicant: Advanced Micro Devices, Inc., Santa Clara, CA (US)

(72) Inventors: Gabriel H. Loh, Bellevue, WA (US); Michael Estlick, Fort Collins, CO (US); Jay Fleischman, Fort Collins, CO (US); Michael J. Schulte, Austin, TX (US); Bradford Beckmann, Bellevue, WA (US); Yasuko Eckert, Bellevue, WA (US)

(73) Assignee: Advanced Micro Devices, Inc., Santa Clara, CA (US)

(21) Appl. No.: 18/088,170

(22) Filed: Dec. 23, 2022

Related U.S. Application Data
(60) Provisional application No. 63/349,559, filed on Jun. 6, 2022.

(51) Int. Cl. G06F 12/1009

(52) U.S. Cl. CPC G06F 12/1009; G06F 2212/1008

(57) ABSTRACT

The disclosed computer-implemented method for interpolating register-based lookup tables can include identifying, within a set of registers, a lookup table that has been encoded for storage within the set of registers. The method can also include receiving a request to look up a value in the lookup table and responding to the request by interpolating, from the encoded lookup table stored in the set of registers, a representation of the requested value. Various other methods, systems, and computer-readable media are also disclosed.

### PRIORITY APPLICATION

This application claims the benefit of U.S. Provisional Application 63/349,559, titled “SYSTEMS AND METHODS FOR INTERPOLATING REGISTER-BASED LOOKUP TABLES,” filed Jun. 6, 2022, which is incorporated by reference herein in its entirety

### BACKGROUND

Lookup tables can be used by accelerated processors to make approximating the output of a variety of calculations more efficient. Despite this, many machine-learning algorithms make use of a variety of transcendental functions that are typically not efficiently supported in hardware accelerators.

### BRIEF DESCRIPTION OF THE DRAWINGS

The accompanying drawings illustrate a number of example implementations and are a part of the specification. Together with the following description, these drawings demonstrate and explain various principles of the present disclosure.

FIG. 1 is an overview diagram of a register-based lookup table system according to one or more implementations.

FIG. 2 is an example of an approach to reducing the size of a lookup table to fit within limited register space according to one or more implementations.

FIG. 3 is an example block diagram of the register-based lookup table system interpolating values from a register-based lookup table to approximate a function according to one or more implementations.

FIG. 4 is a block diagram of an example system for interpolating register-based lookup tables according to one or more implementations.

FIG. 5 is a flow diagram of an example method for interpolating register-based lookup tables according to one or more implementations.

Throughout the drawings, identical reference characters and descriptions indicate similar, but not necessarily identical, elements. While the example implementations described herein are susceptible to various modifications and alternative forms, specific implementations have been shown by way of example in the drawings and will be described in detail herein. However, the example implementations described herein are not intended to be limited to the particular forms disclosed. Rather, the present disclosure covers all modifications, equivalents, and alternatives falling within the scope of the appended claims.

### DETAILED DESCRIPTION OF EXAMPLE IMPLEMENTATIONS

The present disclosure is generally directed to systems and methods for interpolating register-based lookup tables. While some designs can attempt to include specialized/hardwired functional units (e.g., hardware accelerators) for specific functions (e.g., sigmoid, Batch Norm, Gaussian Error Linear Unit or “GELD”, etc.), the pace of algorithmic change in the machine-learning space is so fast that such specialized units can easily become obsolete. In contrast, the implementations described herein can utilize a combination of software programmable lookup tables (LUTs) with vector hardware interpolation units to be able to either precisely or approximately compute the result of arbitrary numerical functions depending on the data width (e.g., half-precision floating point or fp16) and the lookup table storage size.

As one example, relative to machine learning algorithms that involve several computationally expensive numerical function evaluations (e.g., GELU, Batch Norm) that would typically degrade performance (or would otherwise require easily obsoleted hardware units), the systems and methods disclosed herein can deliver higher performance for these operations in a flexible, efficient, algorithm-agnostic, and future-proof manner. To illustrate, the following equation shows how the linear activation function GELU (Gaussian Error Linear Unit) can be approximated (“aGELU”) with 6 multiplications, 2 additions, and a hyperbolic-tangent function.

$$\begin{matrix}GELU ( x ) = xP ( X \leq x ) \\ = x Φ ( x ) \\ \approx 0.5 x ( 1 + tanh [ \sqrt{2 / π} ( x + 0.044715 {x}^{3} ) ]\end{matrix}$$

Mechanisms that can help speed up these operations (as addressed by the implementations of this disclosure) can improve performance for training and inference—especially for transcendental functions like TAN H that typically have low throughput.

In one or more implementations, work other than matrix-multiply can consume significant execution time when attempted by existing hardware accelerators. Such operations (e.g., transcendentals, square root, reciprocals, compound operations) generally involve functions that are inefficient and slow to pipeline for high throughput. As such, and as discussed in greater detail below—implementations of this disclosure can provide increased computational efficiency in a variety of ways, including utilizing, for example, hardware registers as the source of the lookup table inputs instead of using memory space and cache hierarchy. In one or more implementations, the systems and methods described herein can significantly increase throughput for complex functions, transcendentals, etc. while maintaining an acceptable level of machine learning accuracy. Moreover, the systems and methods described herein can further reduce power consumption of an accelerated processor by performing interpolation directly from registers.

As will be described in greater detail below, the present disclosure describes various systems and methods for interpolating register-based lookup tables. In one implementation, a method for interpolating register-based lookup tables can be performed by a computing device including at least one processor and can include identifying, within a set of registers, a lookup table that has been encoded for storage within the set of registers, receiving a request to look up a value in the lookup table, and responding to the request by interpolating, from the encoded lookup table stored in the set of registers, a representation of the requested value.

In one or more implementations, the method can further include encoding the lookup table by identifying a number of bits available within the set of registers and reducing a size of the lookup table to fit the number of bits available within the set of registers. For example, reducing the size of the lookup table can include allocating a number of bits to represent mid-range values in the lookup table, and allocating, relative to the number of bits to represent the mid-range values, fewer bits to represent at least one of: a set of values that are larger than the mid-range values, or a set of values that are smaller than the mid-range values.

In one or more implementations, the lookup table can include a table having representative outputs for a machine-learning function. Additionally, in one or more implementations, the set of registers can include at least two registers of the at least one processor of the computing device. In at least one implementation, interpolating the representation of the requested value comprises identifying an approximation of the requested value within the lookup table. Furthermore, interpolating the representation of the requested value can include identifying an exact representation of the requested value within the lookup table.

In one example implementation, a system for interpolating register-based lookup tables can include at least one physical processor, and physical memory including computer-executable instructions that, when executed by the at least one physical processor, cause the at least one physical processor to: identify, within a set of registers, a lookup table that has been encoded for storage within the set of registers, receive a request to look up a value in the lookup table, and respond to the request by interpolating, from the encoded lookup table stored in the set of registers, a representation of the requested value.

In some example implementations, the above-described method can be encoded as computer-readable instructions on a non-transitory computer-readable medium. For example, a computer-readable medium can include one or more computer-executable instructions that, when executed by at least one processor of a computing device, cause the computing device to: identify, within a set of registers, a lookup table that has been encoded for storage within the set of registers, receive a request to look up a value in the lookup table, and respond to the request by interpolating, from the encoded lookup table stored in the set of registers, a representation of the requested value.

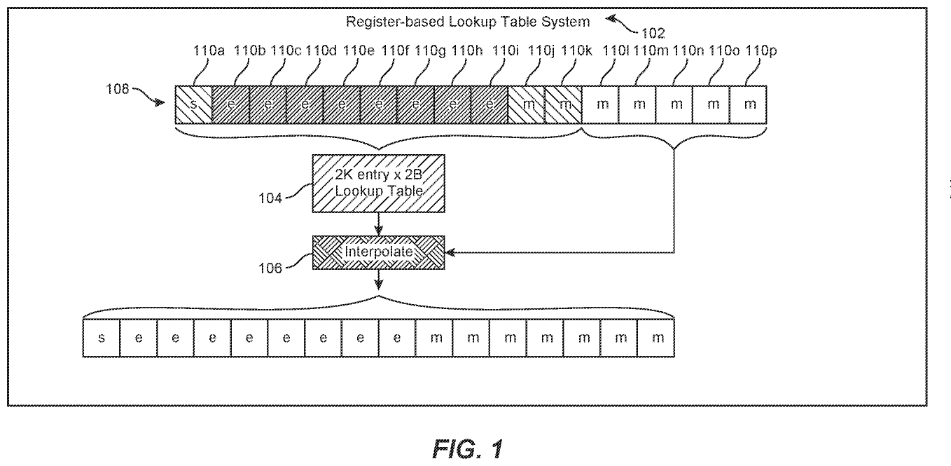

In more detail, FIG. 1 illustrates an overview of a register-based lookup table system 102 that uses a programmable/reconfigurable lookup table (LUT) 104—instead of implementing N different hardware functions (sqrt, a tan, tan h, 1/x, etc.). In one or more implementations, as shown, the register-based lookup table system 102 can utilize the lookup table 104 in connection with an interpolation unit 106 to generate approximate results for complex machine learning-based operations.

For example, as shown in FIG. 1, the register-based lookup table system 102 can maintain the lookup table 104 across a number of register bits in a register 108 and can then interpolate using any remaining register bits. For instance in one implementation, the register-based lookup table system 102 can use a sign bit 110a, exponent bits 110b-110i, and mantissa or fractional bits 110j and 110k for the lookup table 104. In at least one implementation, by using these bits 110a-110k the lookup table 104 can be 2¹¹*2B=41<B in size. As further shown, in at least one implementation, the register-based lookup table system 102 can further interpolate using the remaining mantissa bits 110l-110p. Utilizing this format, for example, the register-based lookup table system 102 can generate GELU equation responses using a single LUT (e.g., the lookup table 104) rather than engaging 6 multiplication operations, 2 addition operations, and 1 tan h operation.

As mentioned above, and in addition to using a lookup table stored in one or more hardware registers, the register-based lookup table system 102 can utilize the interpolation unit 106. In one or more implementations, the interpolation unit 106 can use contents of the lookup table 104 to compute or approximate the result of an arbitrary function (it can be arbitrary due to the fact that a programmer can load the lookup table contents with whatever they want), As such, and in connection with the implementation shown in FIG. 1, the lookup table 104 can be too large to store in one or two x86 AVX-512 registers (e.g., 64 bytes per zmm register), which would be needed if a lookup table and interpolate instruction is limited to no more than three register operands.

Thus, to make the lookup table 104 fit within bit limits of traditional hardware systems, the register-based lookup table system 102 can take advantage of the fact that most functions of interest do not take on completely arbitrarily random values. For example, the register-based lookup table system 102 can leverage the fact that for very large magnitude inputs or very small absolute values, only a few sample points are needed to maintain accurate interpolations/approximations. This implementation is especially true for many of the numerical functions utilized in machine learning. To illustrate, curves of common functions like GELU, ReLU, and ELU quickly flatten out with both very small input and very large inputs.

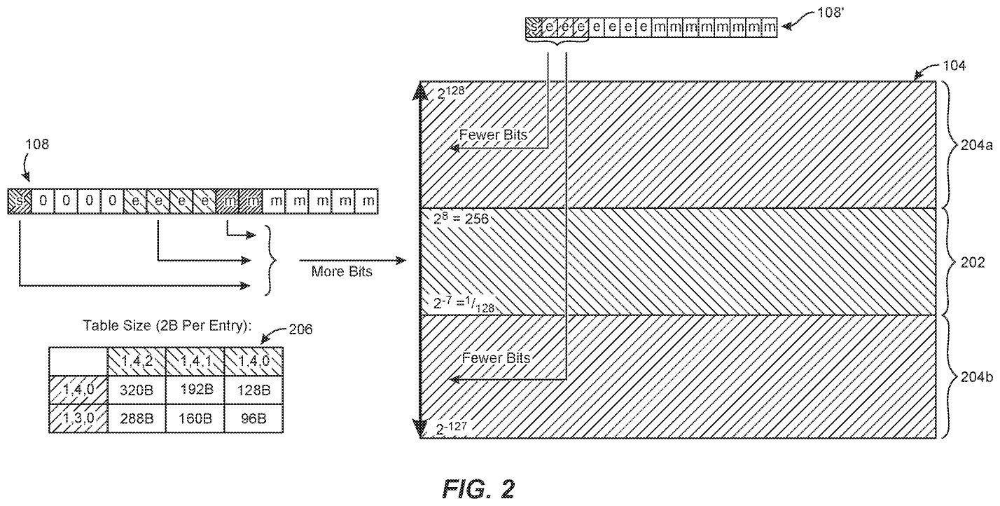

Accordingly, as shown in FIG. 2, the register-based lookup table system 102 can break the lookup table 104 into regions, where a first region 202 covers the numerical range where a floating-point exponent is neither very large nor very small. For example, in the illustrated implementation, this is shown in the register 108 by the four most-significant exponent bits closest to the sign bit (“s”). The register-based lookup table system 102 can further break the lookup table 104 into a top region 204a representing values with exponents that are larger than the threshold range (i.e., with the sign bit in the example register 108′ indicating that the exponent is positive). The register-based lookup table system 102 can also break the lookup table 104 into a bottom region 204b representing values with exponents that are smaller than the threshold range (i.e., with the sign bit in the example register 108′ indicating that the exponent is negative).

In one or more implementations, as shown by the example register 108′, the register-based lookup table system 102 can use the three most-significant exponent bits—in addition to the sign bit—in connection with values represented in the top region 204a and the bottom region 204b. As such, the register-based lookup table system 102 can utilize fewer bits to interpolate very large and/or very small inputs (e.g., within the second region 204) because, for most functions, very large or very small inputs cause little change in the function outputs. Moreover, as shown by the register 108, the register-based lookup table system 102 can utilize a higher number of bits (e.g., the four most-significant bits in addition to the sign bit) for higher precision in connection with a typical range of values of interest (e.g., within the first region 202).

In one or more implementations, the register-based lookup table system 102 can adjust the number of bits utilized within a register depending on the region of the lookup table into which the register indexes. In at least one implementation, utilizing different numbers of the various types of register bits can lead to different storage capacity requirements for the associated lookup tables. In more detail, precision registers (e.g., such as the register 108) and interpolation registers (e.g., such as the example register 108′) can include a sign bit (e.g., the sign bit 110a as shown in FIG. 1), exponent bits (e.g., the exponent bits 110b-110i as shown in FIG. 1), and mantissa bits (e.g., the mantissa bits 110j-110k as shown in FIG. 1). The register-based lookup table system 102, however, may not utilize all of the available exponent bits and mantissa bits of a given register in order to reduce the necessary capacity of an associated lookup table. For example, the table 206 demonstrates how the register-based lookup table system 102 can modify lookup table size by utilizing different numbers of exponent bits and mantissa bits in the registers that index into those lookup tables.

To illustrate, and as shown in the table 206, a precision register (e.g., similar to the register 108) utilizing the sign bit, 4 exponent bits, and 2 mantissa bits (e.g., “1, 4, 2”) can index into a lookup table that is 320B in size with higher precision for typical ranges of values of interest (e.g., such as in the first region 202). Similarly, an interpolation register (e.g., similar to the example register 108′) utilizing the sign bit, 4 exponent bits, and 0 mantissa bits (e.g., “1, 4, 0”) can also index into a lookup table that is 320B in size, although with fewer bits thereby interpolating very large or very small inputs. Additionally, as shown in the table 206, a precision register can index into a lookup table that is 28813 in size utilizing the sign bit, 4 exponent bits, and 2 mantissa bits (e.g., “1, 4, 2”) along with an interpolation register utilizing the sign bit, 3 exponent bits, and 0 mantissa bits (e.g., “1, 3, 0”). The table 206 further illustrates additional bit arrangements for registers that index into lookup tables that are 192B, 160B, 128B, or 96B in size.

In summary, lookup tables utilizing bit arrangements such as those listed along the top of the table 206 are those that use higher precision for typical ranges of values of interest, while lookup tables utilizing bit arrangements such as those listed along the left-hand side of the table 206 are those that use fewer bits to interpolate very large and very small inputs. In at least one implementation, the table 206 can assume the BFloat16 (brain floating-point) format. In additional implementations, the same results can apply to the FP16 (half-precision floating point) format or another suitable format.

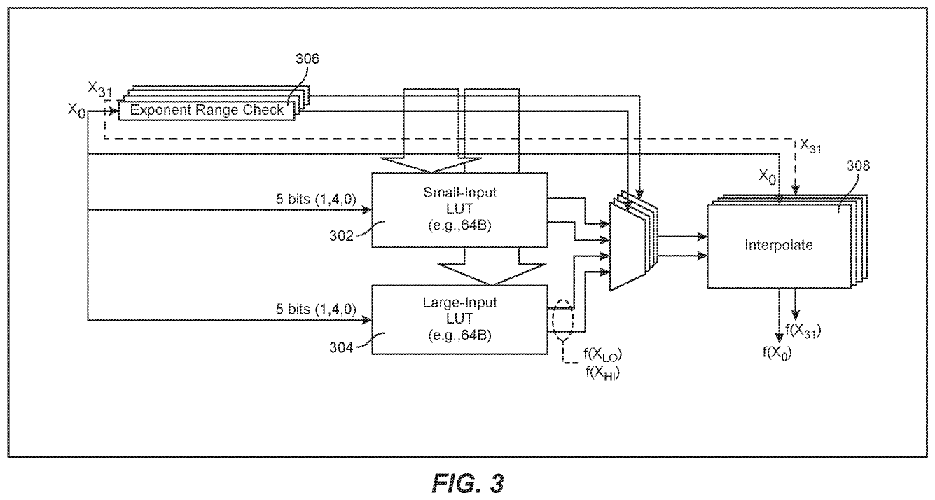

FIG. 3 illustrates a potential implementation of the register-based lookup table system 102 within a CPU. To illustrate, in one example, the register-based lookup table system 102 can execute a new instruction for generic function evaluation. In the example illustrated in FIG. 3, a small-input lookup table 302 can correspond with the first region 202 illustrated in FIG. 2 representing values with exponents closer to zero. In one or more implementations, the small-input lookup table 302 can use five bits for the lookup table index lookup (e.g., one sign bit, four exponent bits, zero mantissa bits), which can require 2⁵=32 entries, and at 2 bytes per entry (for bf16) adds up to a total of 64 bytes.

Similarly, a large-input lookup table 304 can correspond with the second region 204 illustrated in FIG. 2 representing values with higher or larger magnitude exponents. In at least one implementation, the large-input lookup table 304 can also use five bits for the lookup table index lookup (e.g., one sign hit, four exponent hits, and 0 mantissa bits), which can require 2⁵=32 entries, and at 2 bytes per entry (for bf16) adds up to a total of 64 bytes. In at least one implementation, the small-input lookup table 302 and the large-input lookup table 304 can each fit into a single register (e.g., a 512-bit register).

As mentioned above, FIG. 3 illustrates the register-based lookup table system 102 executing a new instruction for generic function evaluation. To illustrate, the generic function can be as follows:

```
_m512BH VGFUNCBF16 (_m512bh src, _m512 LUT1, _m512LUT2)
  For i in [0..31]
    if (abs(src[i] > MAX_LUT1_INPUT)), output[i] =
    interpolate(LUT1, src[i])
    else output[i] = interpolate(LUT2, src[i])
```

In at least one implementation, the function VGFUNCBF16 includes three register operands, two of which (e.g., LUT1, and LUT2 corresponding to the small-input lookup table 302 and large-input lookup table 304, respectively) specify the registers holding the lookup table. The first operand “src” provides input values (x's) (e.g., 32 bfloat16 values packed into a single zmm 512-bit register). If the small-input lookup table 302 and the large-input lookup table 304 store samples correspond to a function “1”, then VGFUNCBF16 takes each “x” from the source (src) register.

Next, as shown in FIG. 3, the register-based lookup table system 102 can perform an exponent range check 306 by using the exponent of that x value to determine which lookup table should be used. The register-based lookup table system 102 further performs a lookup from the corresponding lookup table for the two nearest entries (these can be consecutive) and then performs an interpolation using the interpolation unit 308 based on these two values from the corresponding lookup table to compute/approximate the output f(x). Specifically, the register-based lookup table system 102 can perform the interpolation unit 308 by using the x value to compute X_{LO} and X_{HI} (e.g., two of the closest x values corresponding to lookup table indexes). The register-based lookup table system 102 then uses X_{LO} and X_{HI} to lockup two entries in the lookup table (e.g., f(X_{LO}) and f(X_{HI})). In at least one implementation, the interpolation unit 308 then performs a linear interpolation based on f(X_{LO}) and f(X_{HI}) to estimate the value of f(x).

In one or more implementations, the register-based lookup table system 102 utilizes the interpolation unit to perform this interpolation by using some of the mantissa bits unused by the lookup step. Since there are 32 x's in the input source register (src), this produces 32 f(x) outputs. In at least one implementation, the register-based lookup table system 102 can write these outputs to the destination register. For example, in some implementations, the 102 can write these outputs to the same source register (src) thereby over-writing the inputs.

In some implementations, the register-based lookup table system 102 can determine the exact selection of which exponent and mantissa bits to select from the input (as well as the format of the values and the interpolation function) based on information encoded in the instruction operand. In one example, 6 bits (1, 4, 1) can be used to index into a lookup table. To keep the lookup table in a single register, the register-based lookup table system 102 can reduce each lookup table entry to one byte, corresponding to (1, 5, 2). In some implementations, the interpolation unit 308 can take two one-byte values from consecutive entries, perform an interpolation, and output a two-byte bfloat16 value. Additionally, in some implementations, each lookup table (e.g., the small-input lookup table 302 and the large-input lookup table 304) can have an associated unique interpolation function.

Beyond the example illustrated in FIG. 3, in additional implementations, the register-based lookup table system 102 can use smaller source/destination registers, such as 256-bit (16 input/outputs), or even scalar source/destination registers. In one or more implementations, register size is not critical to the operation of the register-based lookup table system 102. Instead, in one or more implementations, the register-based lookup table system 102 can primarily rely on being able to store the lookup tables in the largest registers possible,

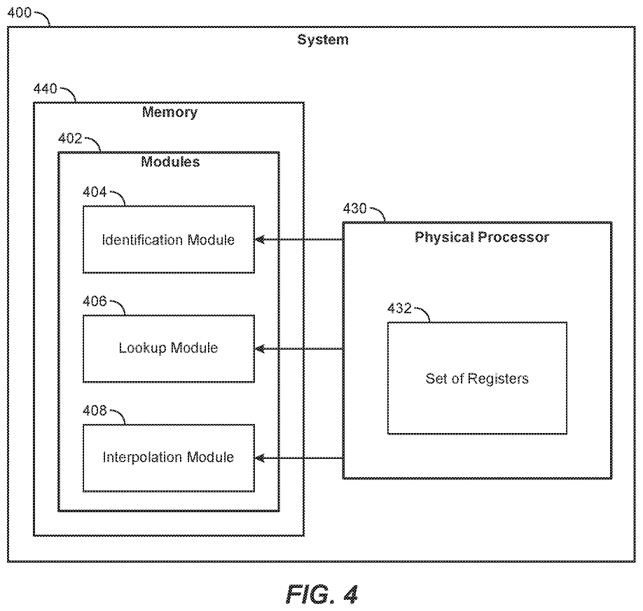

FIG. 4 is a block diagram of an example system 400 for interpolating register-based lookup tables (e.g., the register-based lookup table system 102 discussed above). As illustrated in this figure, the example system 400 can include one or more modules 402 for performing one or more tasks. As will be explained in greater detail below, the modules 402 can include an identification module 404, a lookup module 406, and an interpolation module 408. Although illustrated as separate elements, one or more of the modules 402 in FIG. 4 can represent portions of a single module or application.

In certain implementations, one or more of the modules 402 in FIG. 4 can represent one or more software applications or programs that, when executed by a computing device, can cause the computing device to perform one or more tasks. For example, and as will be described in greater detail below, one or more of the modules 402 can represent modules stored and configured to run on one or more computing devices. One or more of the modules 402 in FIG. 4 can also represent all or portions of one or more special-purpose computers configured to perform one or more tasks. In a preferred implementation, the modules 402 are implemented as hardware (e.g., circuits) in the physical processor 430 rather than being stored as software modules within the memory 440.

As illustrated in FIG. 4, the example system 400 can also include one or more memory devices, such as memory 440. The memory 440 generally represents any type or form of volatile or non-volatile storage device or medium capable of storing data and/or computer-readable instructions. In one example, the memory 440 can store, load, and/or maintain one or more of modules 402. Examples of the memory 440 include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

As illustrated in FIG. 4, the example system 400 can also include one or more physical processors, such as a physical processor 430. The physical processor 430 generally represents any type or form of hardware-implemented processing unit capable of interpreting and/or executing computer-readable instructions. In one example, the physical processor 430 can access and/or modify one or more of the modules 402 stored in memory 440. Additionally or alternatively, the physical processor 430 can execute one or more of the modules 402 to facilitate interpolating register-based lookup tables. Examples of the physical processor 430 include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

As illustrated in FIG. 4, the example system 400 can also include a set of registers 432. The set of registers 432 can include any suitable number of registers that the physical processor 430 uses for executing instructions. For example, the set of registers 432 can include a single register, two registers, or numerous registers. In some examples, the set of registers 432 can be data registers that can hold numerical values such as integer values, floating-point values, and/or any other suitable values. The set of registers 432 can also include registers of any suitable size. For example, the registers within the set of registers 432 can be 8-bit registers, 16-bit registers, 32-bit registers, 64-bit registers, 128-bit registers, etc.

As mentioned above, and as illustrated in FIG. 4, the system 400 can include the identification module 404 within the modules 402. In one or more implementations, the identification module 404 determines which lookup table to apply to an input. For example, the identification module 404 can make this determination by performing an exponent range check (e.g., the exponent range check 306 illustrated in FIG. 3) on the input value. In at least one implementation, the identification module 404 can decide to utilize a small-input lookup table (e.g., such as the small-input lookup table 302 shown in FIG. 3) when the exponent of an input value is closer to zero. Furthermore, the identification module 404 can decide to utilize a large-input lookup table (e.g., the large-input lookup table 304 illustrated in FIG. 3) when the exponent of an input value has a larger magnitude exponent.

As mentioned above, and as illustrated in FIG. 4, the system 400 can include the lookup module 406. In one or more implementations, the lookup module 406 identifies at least two values from a designated lookup table based on bits of an input value. For example, as discussed above with regard to FIG. 3, the lookup module 406 can utilize one or more sign bits, upper exponent bits, lower exponent bits, and mantissa bits to identify the two nearest entries to the input value. In at least one implementation, the two nearest entries can be consecutive.

As further mentioned above, and as illustrated in FIG. 4, the system 400 can include the interpolation module 408. As used herein, the term “interpolate” refers to estimating a value based on a range of values. For example, in one or more implementations, the interpolation module 408 can generate an interpolated value based on at least two input values. For instance, the interpolation module 408 can receive the two values identified within the designated lookup table from the lookup module 406 and generate an interpolated valued based on the received values. In at least one implementation, the interpolation module 408 generates the interpolated value by determining an intermediate value between the received values. For instance, the interpolation module 408 can determine a mean of the received values, a median of the received values, or a different intermediate value between the received values.

Many other devices or subsystems can be connected to the system 400 in FIG. 4. Conversely, all of the components illustrated in FIG. 4 need not be present to practice the implementations described and/or illustrated herein. The devices and subsystems referenced above can also be interconnected in different ways from that shown in FIG. 4. The systems 400 can also employ any number of software, firmware, and/or hardware configurations. For example, one or more of the example implementations disclosed herein can be encoded as a computer program (also referred to as computer software, software applications, computer-readable instructions, and/or computer control logic) on a computer-readable medium.

The term “computer-readable medium,” as used herein, generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

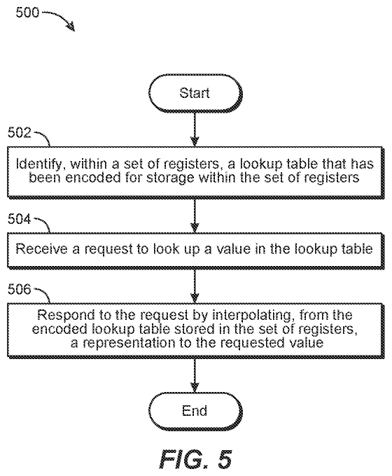

FIG. 5 is a flow diagram of an example computer-implemented method 500 for interpolating register-based lookup tables. The steps shown in FIG. 5 can be performed by any suitable computer-executable code and/or computing system, including system 400 in FIG. 4. In one example, each of the steps shown in FIG. 1-3 can represent an algorithm whose structure includes and/or is represented by multiple sub-steps, examples of which will be provided in greater detail below.

As illustrated in FIG. 5, at step 502 one or more of the systems described herein can interpolate register-based lookup tables. For example, the identification module 404 can, as part of system 400 in FIG. 4, identify, within a set of registers, a lookup table that has been encoded for storage within a set of registers. The identification module 404 can perform step 502 in any suitable manner. For example, the identification module 404 can identify the lookup table to respond to a request for an output of a function of a machine-learning algorithm. Additionally or alternatively, the identification module 404 can identify the lookup table in response to a request for an output of any other suitable type of function.

The term lookup table, as used herein, generally refers to any array of data that can replace runtime computation with an array indexing operation. In some implementations, as discussed above, savings in processing time can be significant, as retrieving a value from a register can be much faster than carrying out an expense computation. In some implementations, a lookup table can be precalculated and/or pre-fetched. In some implementations, a lookup table can be stored in hardware in an application-specific platform. Alternatively, a lookup table can be part of a reconfigurable, hardware-implemented solution provided by an FPGA.

At step 504, the lookup module 406 can, as part of system 400 in FIG. 4, receive a request to lookup a value in the lookup table. The lookup module 406 can receive the request in any suitable manner and/or context. For example, the lookup module 406 can receive the request as a direct addressing request for an output of a function.

At step 506, the interpolation module 408 can, as part of system 400 in FIG. 4, respond to the request by interpolating, from the encoded lookup table stored in the set of registers, a representation of the requested value. The interpolation module 408 can interpolate the representation of the requested value in any suitable manner. For example, in some implementations the interpolation module 408 can interpolate the representation of the requested value by identifying an approximation of the requested value within the lookup table.

Alternatively, the interpolation module 408 can interpolate the representation of the requested value by identifying an exact representation of the requested value within the lookup table. For example, in one implementations, the lookup table may include values that act as indices into an interpolation data structure. As such, and in that implementation, the interpolation module 408 can interpolate the representation of the requested value by using the two or more values identified by the lookup module 406 within the lookup table as indices into a data structure of interpolated values, Using these indices, the interpolation module 408 can identify the exact representation of the requested value.

In some implementations, the systems described herein can encode the lookup table for storage within the set of registers. The systems described herein can encode the lookup table in any suitable manner. For example, the systems described herein can identify a number of bits available within the set of registers and reduce a size of the lookup table to fit the number of bits available within the set of registers. This reduction can be linear across values in the lookup table or can be non-linear based on the data within the lookup table. For example, reducing the size of the lookup table can involve (1) allocating a number of bits to represent a mid-range of values in the lookup table and (2) allocating, relative to the number of bits to represent the mid-range values, fewer bits to represent at least one set of values that are larger than the mid-range values or at least one set of values that are smaller than the mid-range values. Implementations of this disclosure can also use any other suitable algorithm or mechanism to reduce the size of a lookup table to fit within a particular set of registers.

Implementations of this disclosure can provide a variety of advantages over traditional approaches and can be implemented in a variety of contexts. For example, implementations of this disclosure can provide higher performance (in particular significantly higher throughput for complex functions, transcendentals, etc.) than traditional operations with relatively low silicon cost and acceptable impact on machine-learning accuracy. Performing interpolation directly from registers can also reduce power consumption (compared, for example, to a Texture Cache approach in accelerated processors that repeatedly reads data from the cache hierarchy). These advantages can be realized in a variety of systems, including accelerated processors and/or hardware accelerators (e.g., Central Processing Units (CPUs), Graphics Process Units (GPUs), Field-Programmable Gate Arrays (FPGAs), Neural Processing Unites (NPUs), Tensor Processing Units (TPUs), and/or other hardware accelerators, application-specific integrated circuits (ASICs), etc.).

While the foregoing disclosure sets forth various implementations using specific block diagrams, flowcharts, and examples, each block diagram component, flowchart step, operation, and/or component described and/or illustrated herein can be implemented, individually and/or collectively, using a wide range of hardware, software, or firmware (or any combination thereof) configurations. In addition, any disclosure of components contained within other components should be considered example in nature since many other architectures can be implemented to achieve the same functionality.

The process parameters and sequence of steps described and/or illustrated herein are given by way of example only and can be varied as desired. For example, while the steps illustrated and/or described herein can be shown or discussed in a particular order, these steps do not necessarily need to be performed in the order illustrated or discussed. The various example methods described and/or illustrated herein can also omit one or more of the steps described or illustrated herein or include additional steps in addition to those disclosed.

While various implementations have been described and/or illustrated herein in the context of fully functional computing systems, one or more of these example implementations can be distributed as a program product in a variety of forms, regardless of the particular type of computer-readable media used to actually carry out the distribution. The implementations disclosed herein can also be implemented using modules that perform certain tasks. These modules can include script, batch, or other executable files that can be stored on a computer-readable storage medium or in a computing system. In some implementations, these modules can configure a computing system to perform one or more of the example implementations disclosed herein.

The preceding description has been provided to enable others skilled in the art to best utilize various aspects of the example implementations disclosed herein. This example description is not intended to be exhaustive or to be limited to any precise form disclosed. Many modifications and variations are possible without departing from the spirit and scope of the present disclosure. The implementations disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A computer-implemented method for interpolating register-based lookup tables, at least a portion of the computer-implemented method being performed by a computing device comprising at least one processor, the computer-implemented method comprising:
receiving a request to look up a value in a lookup table encoded for storage within a set of registers; and
responding to the request by interpolating, from the encoded lookup table stored in the set of registers, a representation of the requested value.

2. The computer-implemented method of claim 1, further comprising encoding the lookup table by:
identifying a number of bits available within the set of registers; and
reducing a size of the lookup table to fit the number of bits available within the set of registers.

3. The computer-implemented method of claim 2, wherein reducing the size of the lookup table comprises:
allocating a number of bits to represent mid-range values in the lookup table; and
allocating, relative to the number of bits to represent the mid-range values, fewer bits to represent at least one of:
a set of values that are larger than the mid-range values; or
a set of values that are smaller than the mid-range values.

4. The computer-implemented method of claim 1, wherein the lookup table comprises a table having representative outputs for a machine-learning function.

5. The computer-implemented method of claim 1, wherein the set of registers comprises at least two registers of the at least one processor of the computing device.

6. The computer-implemented method of claim 1, wherein interpolating the representation of the requested value comprises identifying an approximation of the requested value within the lookup table.

7. The computer-implemented method of claim 1, wherein interpolating the representation of the requested value comprises identifying an exact representation of the requested value within the lookup table.

8. A system for interpolating register-based lookup tables, the system comprising:
at least one physical processor; and
physical memory comprising computer-executable instructions that, when executed by the at least one physical processor, cause the at least one physical processor to:
receive a request to look up a value in a lookup table encoded for storage within a set of registers; and
respond to the request by interpolating, from the encoded lookup table stored in the set of registers, a representation of the requested value.

9. The system of claim 8, wherein the computer-executable instructions, when executed by the at least one physical processor, further cause the at least one physical processor to encode the lookup table by:
identifying a number of bits available within the set of registers; and
reducing a size of the lookup table to fit the number of bits available within the set of registers.

10. The system of claim 9, wherein the computer-executable instructions, when executed by the at least one physical processor, cause the at least one physical processor to reduce the size of the lookup table by:
allocating a number of bits to represent mid-range of values in the lookup table; and
allocating, relative to the number of bits to represent the mid-range values, fewer bits to represent at least one of:
a set of values that are larger than the mid-range values; or
a set of values that are smaller than the mid-range values.

11. The system of claim 8, wherein the lookup table comprises a table having representative outputs for a machine-learning function.

12. The system of claim 8, wherein the set of registers comprises at least two registers of the at least one physical processor.

13. The system of claim 8, wherein interpolating the representation of the requested value comprises identifying an approximation of the quested value within the lookup table.

14. The system of claim 8, wherein interpolating the representation of the requested value comprises identifying an exact representation of the requested value within the lookup table.

15. A non-transitory computer-readable medium comprising one or more computer-executable instructions that, when executed by at least one processor of a computing device, cause the computing device to:
receive a request to look up a value in a lookup table encoded for storage within a set of registers; and
respond to the request by interpolating, from the encoded lookup table stored in the set of registers, a representation of the requested value.

16. The non-transitory computer-readable medium of claim 15, wherein the one or more computer-executable instructions are programmed to cause the computing device to encode the lookup table by:
identifying a number of bits available within the set of registers; and
reducing a size of the lookup table to fit the number of bits available within the set of registers.

17. The non-transitory computer-readable medium of claim 15, wherein the lookup table comprises a table having representative outputs for a machine-learning function.

18. The non-transitory computer-readable medium of claim 15, wherein the set of registers comprises at least two registers of the at least one processor of the computing device.

19. The non-transitory computer-readable medium of claim 15, wherein interpolating the representation of the requested value comprises identifying an approximation of the requested value within the lookup table.

20. The non-transitory computer-readable medium of claim 15, wherein interpolating the representation of the requested value comprises identifying an exact representation of the requested value within the lookup table.
